(19) United States
(12) Patent Application Publication
(10) Pub. No.: US 2014/0320494 A1
(43) Pub. Date: Oct. 30, 2014

(54) IMAGE PROCESSING APPARATUS, IMAGE PROCESSING METHOD, COMPUTER READABLE NON-TRANSITORY RECORDING MEDIUM AND IMAGE PROCESSING SYSTEM

(71) Applicant: JAPAN AGENCY FOR MARINE-EARTH SCIENCE & TECHNOLOGY, Yokosuka-shi (JP)

(72) Inventors: Shintaro Kawahara, Yokosuka-shi (JP); Fumiaki Araki, Yokosuka-shi (JP); Takeshi Sugimura, Yokosuka-shi (JP); Keiko Takahashi, Yokosuka-shi (JP)

(73) Assignee: JAPAN AGENCY FOR MARINE-EARTH SCIENCE & TECHNOLOGY, Yokosuka-shi (JP)

(21) Appl. No.: 14/329,500

(22) Filed: Jul. 11, 2014

Related U.S. Application Data
(63) Continuation of application No. PCT/JP2012/084066, filed on Dec. 28, 2012.

(30) Foreign Application Priority Data
Jan. 13, 2012 (JP) 2012-005541

(51) Int. Cl. G06T 15/40

(52) U.S. Cl. CPC G06T 15/405
USPC 345/422

(57) ABSTRACT

Provided is an image processing apparatus the calculation cost of which is low. The image processing apparatus is provided with a control means that sets a plurality of planes that form a layer in at least one direction in three dimensional space, sets one plane among the planes as a reference plane, and forms an image on the basis of the relationship between the positions of a visual axis and the reference plane.

### CROSS-REFERENCE TO RELATED APPLICATION

This application is a continuation of International Application PCT/JP2012/084066 which was filed on Dec. 28, 2012, and claims priority from Japanese Patent Application 2012-005541 which was filed on Jan. 13, 2012, the contents of which are herein wholly incorporated by reference.

### TECHNICAL FIELD

The present invention relates to image processing of three-dimensional images.

### BACKGROUND ART

In a conventional volume rendering method based on laminated layers of two-dimensional images having opacity (or transparency), on the occasion of forming a screen based on α-blending, a Z-value based sorting process is performed so that a rendering process is executed in the sequence from a most backward (deepest) plane to a nearest plane in a direction of a visual line.

### DOCUMENT OF PRIOR ART

### Patent Document

[Patent document 1] Japanese Patent Application Laid-Open Publication No. 2000-194878

[Patent document 2] Japanese Patent Application Laid-Open Publication No. H11-66340

[Patent document 3] Japanese Patent Application Laid-Open Publication No. 2003-263651

### SUMMARY

The Z-value based sorting process has, however, a problem in terms of a cost for calculations because this process is invariably executed when a change of the visual line occurs.

It is an object of the present invention to provide an image processing apparatus that is low in cost for the calculations.

### Means for Solving the Problems

A technology of the disclosure adopts the following means in order to solve the problem described above.

Namely, according to a first aspect, an image processing apparatus includes control means to set a plane group including a plurality of planes forming layers in at least one direction in a three-dimensional space, to set any one of the planes of the plane group as a reference plane and to form an image on the basis of a positional relationship between a visual line and the reference plane.

According to a second aspect, the image processing apparatus further includes first forming means to form, when forming an image of a near-sided plane located on a near side along the visual line between the plurality of planes existing in superposition in a direction of the visual line, the image of the near-sided plane on the basis of opacity in an area where a backward plane located backward of the near-sided plane is overlapped with the near-sided plane, wherein the control means forms the images by use of the first forming means between the plurality of planes in a way that prioritizes the plane closer to the reference plane with respect to the planes located on the nearer side along the visual line than the reference plane.

According to a third aspect, the image processing apparatus further includes second forming means to form the image of the backward plane in rear of the near-sided plane by omitting an area overlapped with the near-sided plane located on the near side along the visual line between the plurality of planes existing in superposition in the direction of the visual line, wherein the control means forms the image by use of the second forming means in a way that prioritizes the plane closer to the reference plane with respect to the planes located on the backward side of the reference plane along the visual line.

According to a fourth aspect, an image processing system includes: a first information processing apparatus having: rendering sequence determining means to determine a reference plane from within a plane group including a plurality of planes forming layers in at least one direction, and to determine a rendering sequence in a way that sets the reference plane to be the first in the rendering sequence and prioritizes the plane close to the reference plane; and transmitting means to transmit the plane group and the rendering sequence determined by the rendering sequence determining means; and a second information processing apparatus having: receiving means to receive the plane group and the rendering sequence determined by the rendering sequence determining means; and control means to synthesize images of the planes of the plane group with a display image on the basis of the direction of a visual line and the rendering sequence.

According to a fifth aspect, further in the image processing system, the control means, when synthesizing the image of the plane, synthesizes the image of the plane and the image of the reference plane or the already synthesized display image with a new display image in an area where the image of the plane is overlapped with the image of the reference plane or with the already synthesized display image on the basis of opacity of the plane in the overlapped area when the plane is located on a near side along a visual line.

According to a sixth aspect, still further in the image processing system, the control means, when synthesizing the image of the plane, synthesizes the image of the plane and the image of the reference plane or the already synthesized display image with a new display image in the area where the image of the plane is overlapped with the image of the reference plane or with the already synthesized display image by omitting the image of the plane in the overlapped area when the plane is located on a backward side along the visual line.

A program is executed by the information processing apparatus, whereby the aspect of the disclosure may also be realized. A configuration of the disclosure can be specified by way of a program or a non-transitory recording medium recorded with the program for processes implemented by the respective means in the aspects described above to be executed with respect to the information processing apparatus. Further, the configuration of the disclosure may also be specified by way of a method by which the information processing apparatus executes the processes implemented by the respective means described above. The aspect of the disclosure may be realized in such a manner that a plurality of information processing apparatuses executes the program by sharing the processes with each other.

According to the technology of the disclosure, it is feasible to provide the image processing apparatus that is low in cost for the calculations.

### BRIEF DESCRIPTION OF THE DRAWINGS

FIG. 1 is a diagram illustrating an example of a configuration of an image processing apparatus.

FIG. 2 is a diagram illustrating an example of an information processing apparatus.

FIG. 3 is a flowchart illustrating an example of an operating flow of the image processing apparatus.

FIG. 4 is a diagram illustrating an example of polygon data.

FIG. 5 is a diagram illustrating an example of a slice plane group.

FIG. 6 is a diagram illustrating an example (1) of slice planes and a rendering sequence.

FIG. 7 is a diagram illustrating an example (2) of the slice planes and the rendering sequence.

FIG. 8 is a diagram illustrating an example (3) of the slice planes and the rendering sequence.

FIG. 9 is a diagram illustrating and example of the polygon data (slice plane data) generated by a geometry converting unit.

FIG. 10 is a diagram illustrating an example of Z-value data on a pixel-by-pixel basis (screen coordinates) with respect to the slice plane data (polygon ID001) calculated by a rendering processing unit.

FIG. 11 is a flowchart illustrating an example (1) of an operating flow of the rendering process by the rendering processing unit.

FIG. 12 is a flowchart illustrating an example (2) of the operating flow of the rendering process by the rendering processing unit.

FIG. 13 is a diagram illustrating an example of image data.

FIG. 14 is a diagram illustrating an example (1) of a display result through processing by the rendering processing unit.

FIG. 15 is a diagram illustrating an example (2) of the display result through the processing by the rendering processing unit.

FIG. 16 is a diagram illustrating an example (3) of the display result through the processing by the rendering processing unit.

FIG. 17 is a diagram illustrating an example of an image processing system in a modified example.

### DESCRIPTION OF EMBODIMENTS

The following is a description of an image processing apparatus capable of controlling, in volume rendering based on laminated layers of two-dimensional images exhibiting opacity, an image rendering sequence and executing a rendering process surely and efficiently.

An embodiment will hereinafter be described with reference to the drawings. A configuration of the embodiment is an exemplification, and a configuration of the disclosure is not limited to a specific configuration of the embodiment of the disclosure. The specific configuration corresponding to the embodiment may properly be adopted on the occasion of implementing the configuration of the disclosure.

### First Embodiment

(Example of Configuration)

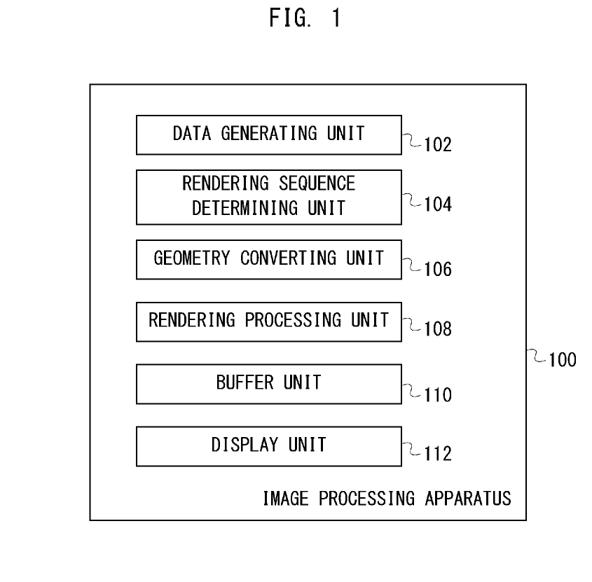

FIG. 1 is a diagram illustrating an example of a configuration of the image processing apparatus. An image processing apparatus 100 includes a data generating unit 102, a rendering sequence determining unit 104, a geometry converting unit 106, a rendering processing unit 108 and an output unit 110. The respective processing units may operate in separation of plural processing units. Further, two or more processing units of these processing units may operate in the form of one single processing unit.

The data generating unit 102 generates polygon data and texture data from source data. The source data are, e.g., three-dimensional position coordinate data and value data corresponding to respective positions. The source data are not construed in any way as limiting a source of the generation thereof in carrying out the present invention. The source data can be acquired from a variety of measurement devices, measurement instruments, diagnostic devices, image forming devices, computer simulations, numeric analyses, etc.

The data generating unit 102 may generate display data containing the polygon data. The polygon data are herein defined mainly as slice plane group data. The slice plane group data contain plural pieces of slice plane data. The data generating unit 102 may generate the slice plane group data containing plural pieces of borderless slice plane data.

The rendering sequence determining unit 104 determines a rendering sequence of the respective pieces of slice plane data in the slice plane group data.

The geometry converting unit 106 converts the polygon data generated by the data generating unit 102 into numeric data to be displayed on a screen.

The rendering processing unit 108 executes a rendering process on the basis of the numeric data converted by the geometry converting unit 106 and the rendering sequence determined by the rendering sequence determining unit 104, thereby generating image data for displaying images on the display device.

A buffer unit 110 is stored with the polygon data and viewpoint data generated by the data generating unit 102, a slice plane data rendering sequence determined by the rendering sequence determining unit 104, data used for the rendering process of the rendering processing unit 108, and so on. The buffer unit 110 can be stored with whatever types of data used in the image processing apparatus 100. The buffer unit 110 may also be realized by a plurality of storage devices.

A display unit 112 displays the images based on the image data processed by the rendering processing unit 108. The display unit 112 may also display the images on an external display device existing outside the image processing apparatus 100. Further, the display unit 112 transmits the image data to an external information processing apparatus existing outside the image processing apparatus 100, and may also display the images based on the display data on a display unit of the external information processing apparatus.

The image processing apparatus 100 can be realized by use of a dedicated or general-purpose computer such as a personal computer (PC), a server machine, a work station (WS), a PDA (Personal Digital Assistant), a smart phone, a mobile phone and a car navigation system or by use of electronic equipment mounted with the computer. Respective components configuring the image processing apparatus 100 may be mounted on a server and a client, separately.

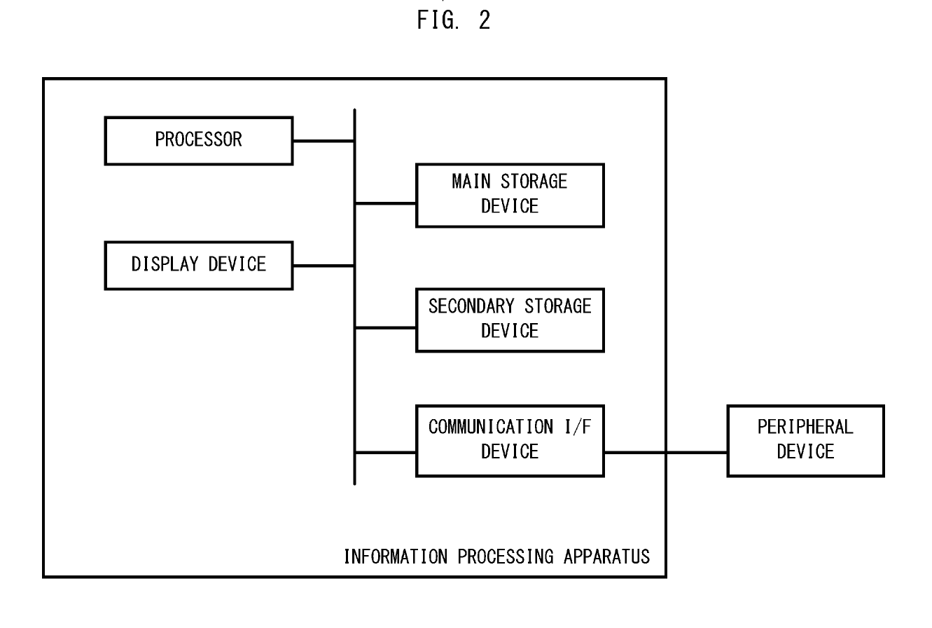

FIG. 2 is a diagram illustrating the information processing apparatus. In the example of FIG. 2, the computer, i.e., the information processing apparatus includes a processor, a main storage device, a secondary storage device, a display device and an interface device such as a communication interface device with peripheral devices. The main storage device and the secondary storage device are defined as non-transitory computer readable recording mediums. The information processing apparatus may not include the display device.

The computer can, with the processor loading a program stored on the recording medium into an operation area of the main storage device and executing the program and with the peripheral device being controlled through execution of the program, realize a function matching with a predetermined purpose.

The processor is exemplified by a CPU (Central Processing Unit), a GPU (Graphics Processing Unit) and a DSP (Digital Signal Processor).

The main storage device includes, e.g., a RAM (Random Access Memory) and a ROM (Read Only Memory).

The secondary storage device is exemplified by an EPROM (Erasable Programmable ROM) and a hard disk drive (HDD). Further, the secondary storage device can include a removable medium, i.e., a portable recording medium. The removable medium is a USB (Universal Serial Bus) memory or a disc recording medium such as a CD (Compact Disc) and a DVD (Digital Versatile Disc).

The display device is a device to display the image such as a CRT (Cathode Ray Tube) display and an LCD (Liquid Crystal Display). The display device may include a storage device such as a VRAM (Video RAM) and a RAM.

The communication interface device (communication I/F device) is an exemplified by a LAN (Local Area Network) interface board and a wireless communication circuit for performing wireless communications.

The peripheral device includes, in addition to the secondary storage device and the communication interface device, an input device such as a keyboard and a pointing device and an output device such as a display device and a printer. Further, the input device can include a video/image input device such as a camera and a voice/sound input device such as a microphone. Moreover, the output device can include a voice/sound output device such as a loudspeaker.

The computer to realize the image processing apparatus 100, with the processor loading the program stored on the secondary storage device into the main storage device and executing the program, realizes functions as the data generating unit 102, the rendering sequence determining unit 104, the geometry converting unit 106, the rendering processing unit 108 and the display unit 122. On the other hand, the buffer units 110 are provided in storage areas of the main storage device, the secondary storage device and a storage device within the display device.

A series of processes can be, though executable hardwarewise, also executed softwarewise.

Steps of describing the program include, of course, processes executed in time-series according to the sequence described and also processes executed in parallel or individually even if not necessarily executed in time-series.

(Operational Example)

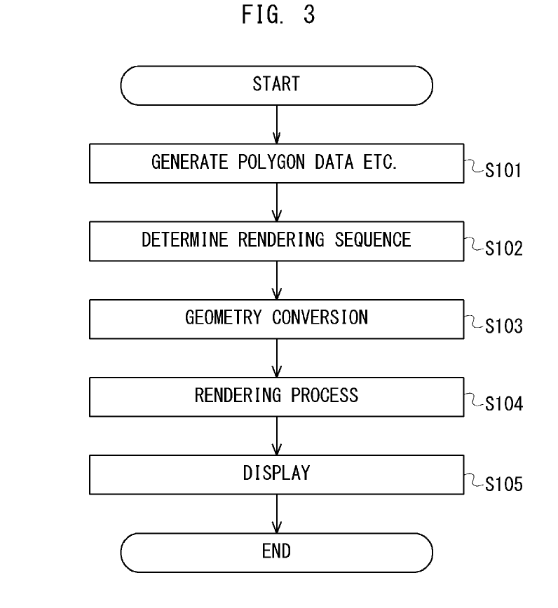

FIG. 3 is a flowchart illustrating an example of an operating flow of the image processing apparatus.

The data generating unit 102 of the image processing apparatus 100 generates the polygon data (slice plane group data) and the texture data on the basis of the source data (S101). The source data are acquired from the storage devices, the peripheral devices, etc. Further, the source data may also be acquired from the external information processing apparatus etc via a network. The source data are defined as data becoming a source of the image data of the images to be displayed. The source data are the three-dimensional position coordinate data in a three-dimensional area and the numeric data corresponding to respective positions. Three-dimensional coordinates may, without being limited to an orthogonal coordinate system, entail adopting other coordinate systems such as a polar coordinate system and a cylindrical coordinate system. The polygon data contain a three-dimensional coordinate of a vertex of a slice plane, a normal vector and texture coordinates. Herein, the polygon data are generates as slice plane data. The data generating unit 102 generates plural pieces of slice plane data on the basis of the source data. Slice planes of the slice plane data are parallel to each other. A group of plural pieces of slice plane data are referred to also as slice plane group data. Plural sets of slice plane group data may also be generated. The texture data are data for mapping textures to a polygon. The texture data contain, e.g., items of information such as values, colors and opacity based on the source data per coordinate. An associative relationship between the values, the colors and the opacity based on the source data may be prepared separately from the texture data and stored on the buffer unit 110 etc. The slice plane group data have at least three slice planes. The generated polygon data and texture data are stored on the buffer unit 110.

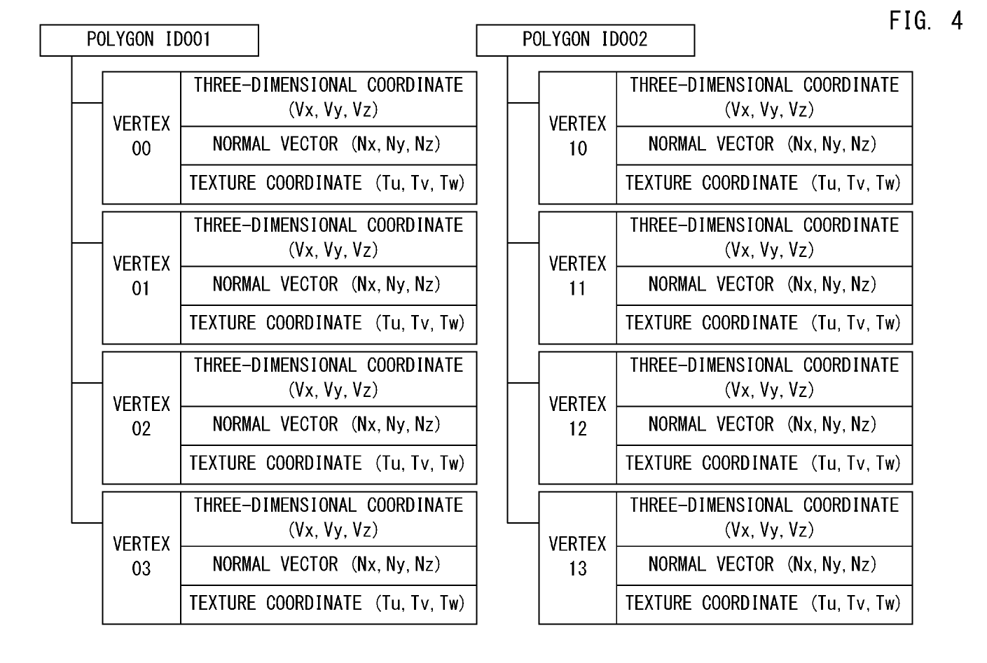

FIG. 4 is a diagram illustrating an example of the polygon data. FIG. 4 depicts a polygon ID001 and a polygon ID002 by way of an example of the polygon data. Each of the polygon ID001 and the polygon ID002 is a quadrangle polygon having four vertexes. In the example of FIG. 4, each of the polygon ID001 and the polygon ID002 is a one set of slice plane data. The four vertexes in one set of slice plane data exist on the same plane. The four vertexes in one set of slice plane data correspond to the vertexes of the polygon contained in the slice plane data. The respective pieces of slice plane data are parallel to each other. In the example of FIG. 4, each vertex contains the three-directional coordinates, the normal vector and the texture coordinates. Herein, the normal vector is defined as a normal vector of the slice plane. The polygon data used herein are of the parallel slice planes, and hence each vertex may not have the normal vector. The example illustrated in FIG. 4 is an example of the texture coordinates on the occasion of using the three-directional coordinates. In the case of using the two-dimensional image data groups as textures, the texture coordinates become two-dimensional (Tu, Tv).

The single piece of slice plane data may be expressed by two triangular polygons sharing one side with each other. The triangular polygon has three vertexes. In FIG. 4, the normal vector and the texture coordinates are stored together with the individual vertex coordinates. However, one normal vector and the texture may also be defined with respect to a tuple of polygon vertex coordinates (a tuple of 3 vertexes, a tuple of 4 vertexes, etc.).

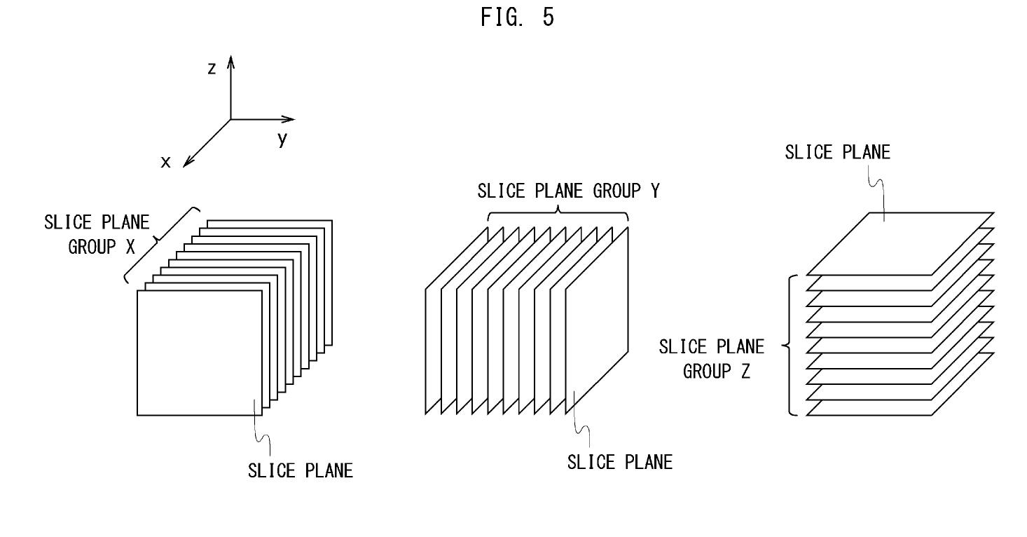

FIG. 5 is a view illustrating an example of the slice plane groups. In the example of FIG. 5, there are illustrated a slice plane group X including the planes orthogonal to an x-axis, a slice plane group Y including the planes orthogonal to a y-axis and a slice plane group Z including the planes orthogonal to a z-axis. The respective slice planes of one slice plane group do not intersect each other. The data generating unit 102 generates the slice plane group data based on at least one slice plane group in accordance with a position of a viewpoint to be assumed and a direction of a visual line. For example, if the direction of the visual line to be assumed is approximately parallel to the z-axis, the slice plane group data are generated, the group data being based on the slice plane group z including the planes orthogonal to the z-axis in FIG. 5. Further, the data generating unit 102 may also generate the slice plane group data including a plurality of planes (slice planes) orthogonal to a direction different from spatial axes (x-axis, y-axis and z-axis).

Moreover, the slice plane may be defined as a part of spherical surface of a sphere, and the slice plane group may also be defined as an aggregation of parts of the spherical surfaces of concentric spheres each having a different radius.

Referring back to the operating flow in FIG. 3, the rendering sequence determining unit 104 of the image processing apparatus 100 determines a rendering sequence of the slice plane data (S102). The rendering sequence is a sequence of processing the slice planes in a rendering process. The rendering sequence determining unit 104 determines the sequence of processing the plural pieces of slice plane data of one set of slice plane group data in the rendering process. The rendering sequence is stored on the buffer unit 110.

In one set of slice plane group data, the rendering sequence determining unit 104 sets, as a reference plane, any one of the slice planes exclusive of the slice planes at both ends from within the plurality of slice planes arranged from one end to the other end. The rendering sequence determining unit 104 determines this reference plane as the slice plane to be processed first. The rendering sequence determining unit 104 determines a processing sequence from the closest to the reference plane toward one end from this reference plane. Further, the rendering sequence determining unit 104 determines a processing sequence from the closest to the reference plane toward the other end from this reference plane. The rendering sequence determining unit 104 thus determines the rendering sequence with respect to the slice planes. The rendering sequence is determined so as to be processed toward the slice plane at the end from the slice plane serving as the reference plane.

Moreover, the rendering sequence determining unit 104 may determine the rendering sequence as below. The rendering sequence determining unit 104 determines the slice plane serving as the reference plane to be the plane that is processed first. Next, the slice plane closest to the reference plane on one end side in the plurality of slice planes arranged from one end to the other end, is determined to be processed second, and the slice plane closest to the reference plane on the other end side is determined to be processed third. The processing sequence of processing up to the slice planes at both ends may also be determined in such a way that the slice plane closest second to the reference plane on one end side is thereafter determined to be processed fourth.

The rendering sequence determining unit 104 can determine, in the slice planes arranged from one end to the other end in the slice plane group data, an approximately central slice plane as the reference plane.

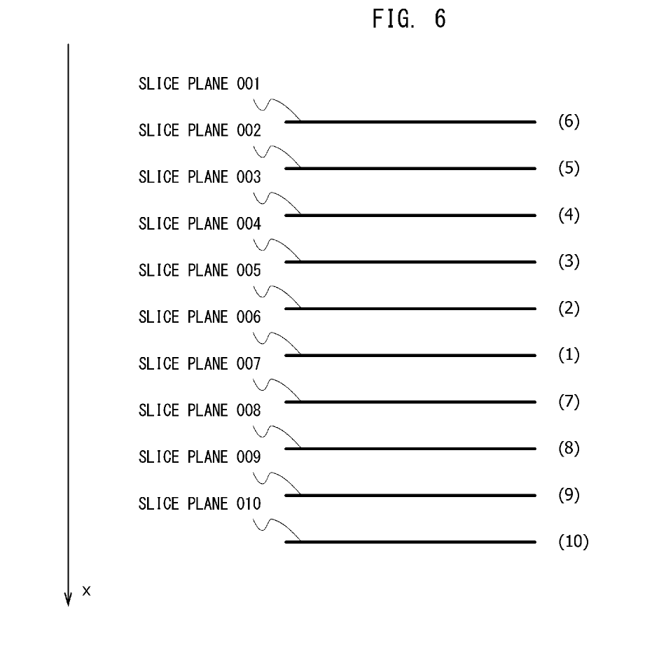

FIG. 6 is a diagram illustrating an example (1) of the slice planes and the rendering sequence. The example in FIG. 6 is given by way of an illustration of the slice plane group as viewed from a direction orthogonal to the direction of the normal line of the slice plane. Further, in the example of FIG. 6, the direction of the visual line is assumed to be the x-axis direction or inclined at an angle smaller than 90 degrees to the x-axis or a direction opposite thereto. The example in FIG. 6 is that the slice planes are arranged from one end to the other end, i.e., from a slice plane 001 to a slice plane 010. Herein, an approximately central slice plane 006 is determined as the reference plane (the first plane in the rendering sequence). Further, a slice plane 005 through the slice plane 001, i.e., from the reference plane toward one end, are determined as the second through sixth planes in terms of the rendering sequence. Still further, a slice plane 007 through the slice plane 010, i.e., the slice planes from the reference plane toward the other end, are determined as the seventh through tenth planes in terms of the rendering sequence.

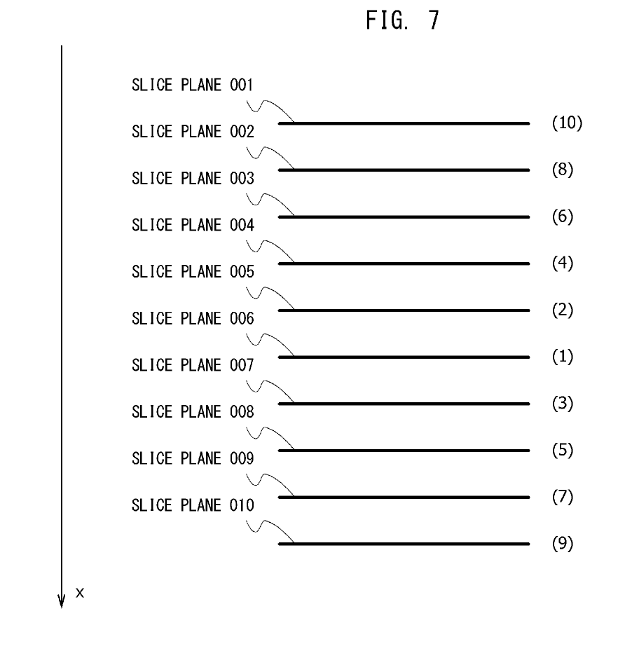

FIG. 7 is a diagram illustrating an example (2) of the slice planes and the rendering sequence. The example in FIG. 7 is that the slice planes are arranged from one end to the other end, i.e., from the slice plane 001 to the slice plane 010. Herein, the approximately central slice plane 006 is determined as the reference plane (the first plane in the rendering sequence). Further, the slice plane 005 closest to the reference plane on one end side is determined as the second plane in the rendering sequence. Furthermore, the slice plane 007 closest to the reference plane on the other end side is determined as the third plane in the rendering sequence. Then, the slice plane 004 closest second to the reference plane on one end side is determined as the fourth plane in the rendering sequence. Hereafter, as in FIG. 7, other slice planes are determined likewise in terms of the rendering sequence.

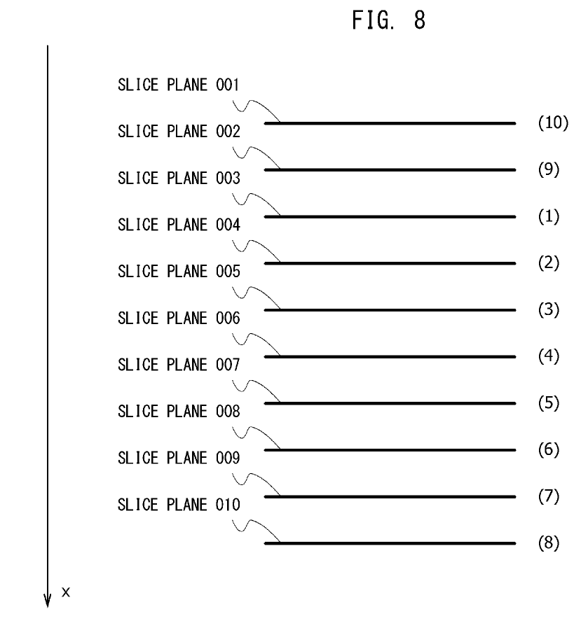

FIG. 8 is a diagram illustrating an example (3) of the slice planes and the rendering sequence. As in the example of FIG. 8, the slice plane 003 not defined as the approximately central slice plane may be determined as the reference plane. The rendering sequence as in the example of FIG. 8 is effective in a case where the viewpoint exists on the side of, e.g., the slice plane 010 in many cases. A reason why so is that the opacity about plane segments overlapped with the slice planes anterior to the reference plane is ignored on the slice planes posterior to the reference plane as viewed from the viewpoint, however, this contrivance enables a further reduction in number of the slice planes with the opacity being ignored in the case where the viewpoint exists on the side of the slice plane 010.

Referring back to the operating flow in FIG. 3, the geometry converting unit 106 of the image processing apparatus 100 performs a geometry-conversion (S103). The image processing apparatus 100 receives designation of viewpoint data from a user etc. via the input device etc. till starting the geometry conversion. The viewpoint data contain, e.g., coordinates of the viewpoint, a direction (visual line) of a sight line, a range to be displayed, a size of the image, a view angle, etc. Further, the image processing apparatus 100 extracts, based on the viewpoint data, which slice plane group data is used. The image processing apparatus 100 extracts, as the slice plane group data for use, the slice plane group data in which the direction of the normal line of the slice plane is approximately parallel to the direction of the visual line.

The geometry converting unit 106 performs, based on the viewpoint data, the geometry conversion on each set of slice plane data of the determined slice plane group data. The geometry converting unit 106 converts, based on the viewpoint data, each set of slice plane data into a two-dimensional coordinate space on a display screen. The converted polygon data are stored on the buffer unit 110.

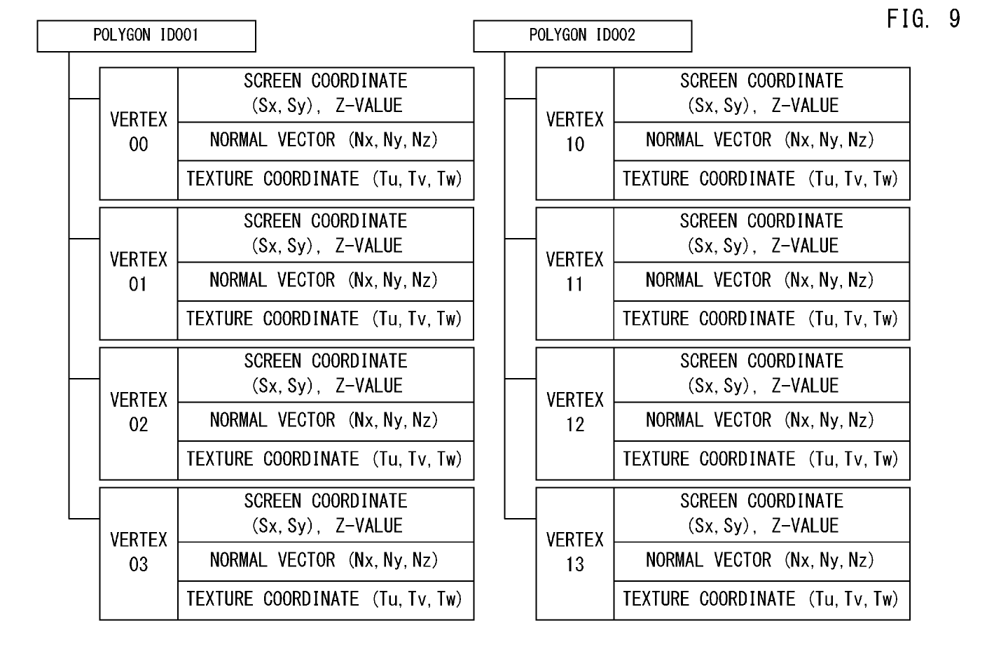

FIG. 9 is a diagram illustrating an example of the polygon data (slice plane data) generated by the geometry converting unit. In the example of FIG. 9, the three-dimensional coordinates of each vertex of the polygon data (slice plane data) in FIG. 4 are converted into screen coordinates (Sx, Sy) on the display screen and a Z-value indicating a depth within the display screen. The Z-value becomes larger as getting farther from the viewpoint. The Z-value of an arbitrary point A has, e.g., a positive correlation with a distance between the point A and a plane, passing through the viewpoint, with the visual line serving as the normal line.

Referring back to the operating flow in FIG. 3, the rendering processing unit 108 of the image processing apparatus 100 executes the rendering process (S104).

To begin with, the rendering processing unit 108 extracts the converted polygon data (slice plane data) by use of the geometry converting unit 106. Further, the rendering processing unit 108 calculates Z-value data on the basis of screen coordinates of the vertexes of the respective slice planes and the Z-values with respect to all pixels (coordinate points) with a range surrounded by the respective vertexes within each slice plane of the extracted slice plane data. If the screen coordinates of the pixels are beyond the display screen, the pixels outside the display screen may not be calculated. The Z-values of the respective pixels can be calculated by conducting an interpolation arithmetic operation on the basis of the screen coordinates of the vertexes and the Z-values. The calculated Z-value data on a pixel-by-pixel basis of each slice plane are stored on the buffer unit 110. Herein, the rendering processing unit 108 calculates color data and opacity data (α-value) on the pixel-by-pixel basis of each slice plane on the basis of the texture coordinates of the vertexes of each slice plane and the texture data thereof, and may store these items of data together with the Z-value data on the buffer unit 110. The color data and the opacity data stored herein may also be used on the occasion of the rendering process that will be explained later on.

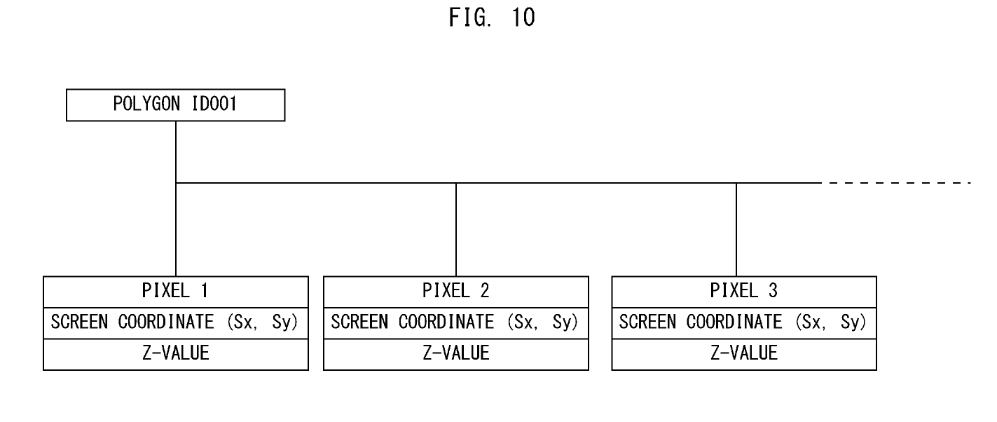

FIG. 10 is a diagram illustrating an example of the Z-value data on the pixel-by-pixel basis (screen coordinates) with respect to the slice plane data (polygon ID001) calculated by the rendering processing unit. In the example of FIG. 10, the Z-values are given with respect to the respective screen coordinates within the slice planes of the polygon ID001.

Next, the rendering processing unit 108 executes the rendering process to generate the image data to be displayed on the screen on the basis of the texture coordinates of the vertexes, the texture data and the Z-value per screen coordinates about each slice plane as in FIG. 10. An in-depth description of the rendering process will be made later on. The image data are stored on the buffer unit 110.

The display unit 112 of the image processing apparatus 100 displays the images on the basis of the image data stored on the buffer unit 110 (S105). The display unit 112 may display the images on a display device provided outside the image processing apparatus 100. Further, the display unit 112 transmits the image data to the information processing apparatus provided outside the image processing apparatus 100, and may display the images based on the image data on a display unit of the external information processing apparatus.

(Rendering Process)

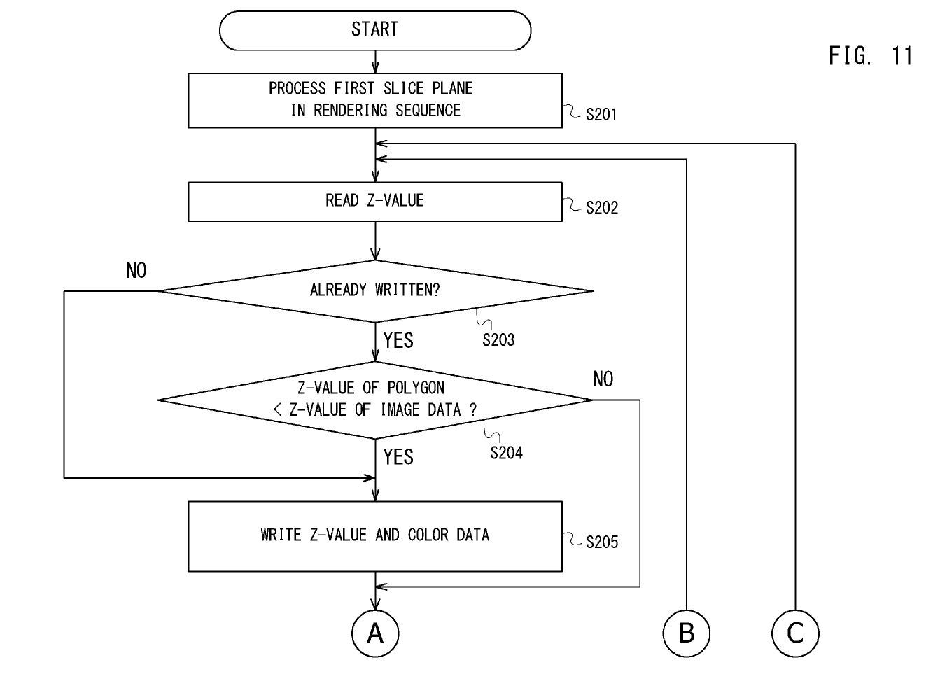

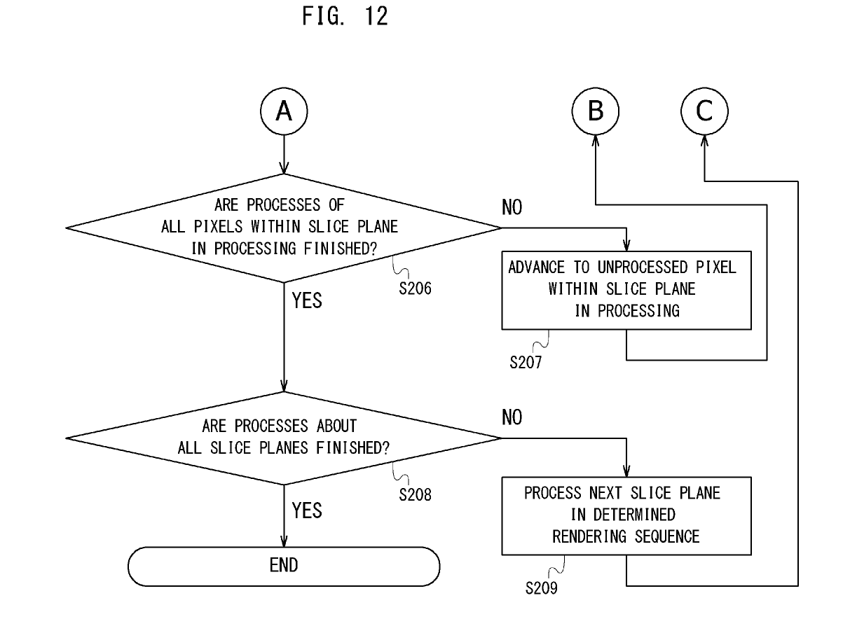

FIGS. 11 and 12 are flowcharts each illustrating an operating flow of the rendering process by the rendering processing unit. The symbols [A], [B], [C] in FIG. 11 are continued to [A], [B], [C] in FIG. 12.

The rendering processing unit 108 reads the polygon data (slice plane data) that are the first in terms of the rendering sequence. The first polygon data in the rendering sequence are the slice plane data of the reference plane. The rendering processing unit 108 reads the Z-values of the respective screen coordinates (pixels) on the reference plane, and calculates the color data of the pixels on the basis of the texture coordinates of the vertexes and the texture data of the reference slice plane. The rendering processing unit 108 writes, to the buffer unit 110, the color data and the Z-value data as the image data on the pixel-by-pixel basis of the reference slice plane throughout (S201). Supposing that the images embrace a background image, the rendering processing unit 108 calculates the opacity (α-value) together with the color data, blends the color data of the background image with the color data of the reference plane, and writes the Z-value data and the color data to the image data. Next, though the processing advances to step S202, the slice plane, which is the second in the rendering sequence, is processed in step S202 to which the processing advances from step S201.

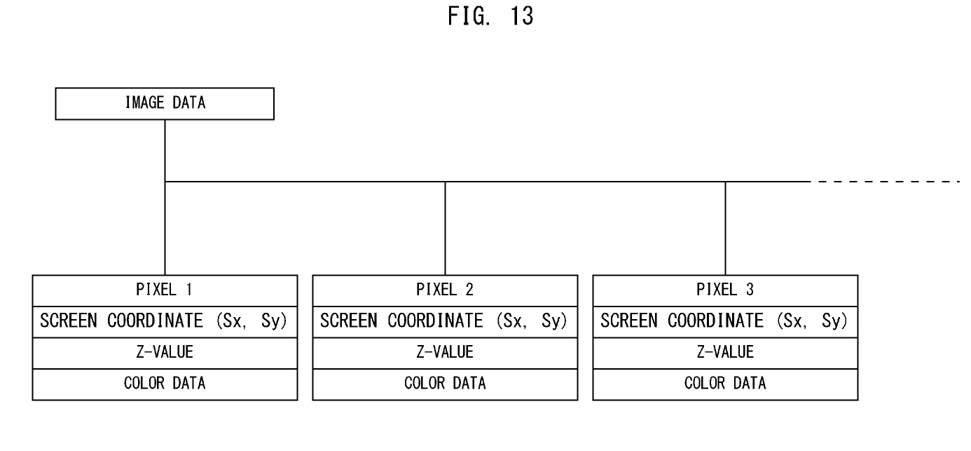

FIG. 13 is a diagram illustrating an example of the image data. In the image data of FIG. 13, the screen coordinates, the color data and the Z-values are associated with each other with respect to all the pixels within the display screen. Within the image data, an initial color (e.g., black or another designated color) serving as the color data and a value indicating the farthest position as the Z-value or a value indicating a comparison not yet being made are written to the pixels deemed as not-yet-written pixels. Further, the color data and the Z-value may also be null with respect to the not-yet-written pixels within the image data. The image data are stored on the buffer unit 110.

Processes in step S202-S209 will hereinafter be repeatedly executed with respect to unprocessed slice planes. In step S202, the rendering processing unit 108 reads the Z-value with respect to one unprocessed pixel of the slice plane in processing (S202). It is herein assumed that the Z-values are previously calculated in all the pixels, however, the Z-value of the pixel in processing underway of the slice plane in processing underway may be calculated also when the Z-value is used in steps S201 and S202.

In step S203, the rendering processing unit 108 reads the pixel data of the image data with respect to the pixel (the pixel in processing underway of the slice plane in processing underway) with the Z-value being read in step S202, and checks whether the color data is already written to the pixel of the image data or not (S203).

If the color data is not yet written to the pixel of the image data with respect to the pixel in processing underway of the slice plane in processing underway (S203; NO), the processing advances to step S205. Whereas if the color data is already written to the pixel of the image data with respect to the pixel in processing underway of the slice plane in processing underway (S203; YES), the rendering processing unit 108 compares the Z-value of the pixel in processing underway of the slice plane in processing underway with the Z-value of the pixel in processing underway in the image data (S204).

If the Z-value of the pixel in processing underway of the slice plane in processing underway is smaller than the Z-value of the pixel in processing underway in the image data (S204; YES), the processing advances to step S205. At this time, the pixel in processing underway of the slice plane in processing underway is located anterior to the already-written color data.

Whereas if the Z-value of the pixel in processing underway of the slice plane in processing underway is larger than the Z-value of the pixel in processing underway in the image data (S204; NO), the processing advances to step S206. Hereat, the pixel in processing underway of the slice plane in processing underway is located posterior to the already-written color data. Hence, the pixel in processing underway of the slice plane in processing underway is not written to the image data. Herein, it follows that the process is finished with respect to the pixel in processing underway of the slice plane in processing underway.

In step S205, the rendering processing unit 108 calculates the color data and the opacity data (α-value) with respect to the pixel in processing underway of the slice plane in processing underway on the basis of the texture coordinates of the vertexes of the slice plane in processing underway and the texture data. The rendering processing unit 108 calculates new color data (α-blending) on the basis of the opacity data and the color data of the pixel in processing underway of the slice plane in processing underway and the color data of the pixel in processing underway of the image data. The rendering processing unit 108 rewrites the Z-value and the color data of the pixel in processing underway of the image data into the Z-value and the calculated new color data of the pixel in processing underway of the slice plane in processing underway (S205). Herein, it follows that the process is finished with respect to the pixel in processing underway of the slice plane in processing underway.

In step S206, the rendering processing unit 108 checks whether the processes are finished with respect to all the pixels within the slice plane in processing underway or not (S206). If the processes are finished with respect to all the pixels within the slice plane in processing underway (S206; YES), the processing advances to step S208. Herein, it follows that the process is finished with respect to the pixel in processing underway of the slice plane in processing underway.

Whereas if the processes are not finished with respect to all the pixels within the slice plane in processing underway (S206; NO), the rendering processing unit 108 sets another unprocessed pixel as the pixel in processing underway, and the processing loops back to step S202 (S207).

In step S208, the rendering processing unit 108 checks whether the processes are finished with respect to all the slice planes or not (S208). If the processes are not yet finished with respect to all the slice planes (S208; NO), the rendering processing unit 108 sets the next pixel in sequence of the slice plane as the pixel in processing underway in accordance with the rendering sequence determined by the rendering sequence determining unit 104.

Whereas if the processes are finished with respect to all the slice planes (S208; YES), the processes of the rendering processing unit 108 are finished. The image data at this point become the image data to be displayed on the screen. Herein, the Z-values of the respective pixels in the image data may be deleted.

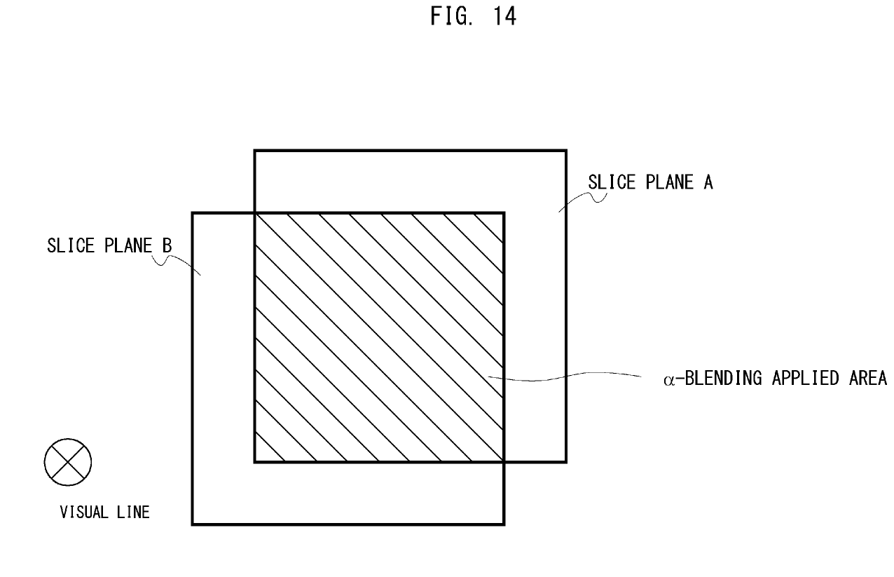

FIGS. 14, 15 and 16 are diagrams illustrating examples of display results via the processing of the rendering processing unit. In these drawing throughout, a direction toward the undersurface from the surface of the drawing corresponds to a direction of the visual line.

In the example of FIG. 14, a slice plane A serves as the reference plane, while a slice plane B is a slice plane existing anterior to the slice plane A. The slice plane A is rendered earlier, and the slice plane B is rendered later. The rendering is performed by an α-blending technique in an area where the slice plane A is overlapped with the slice plane B.

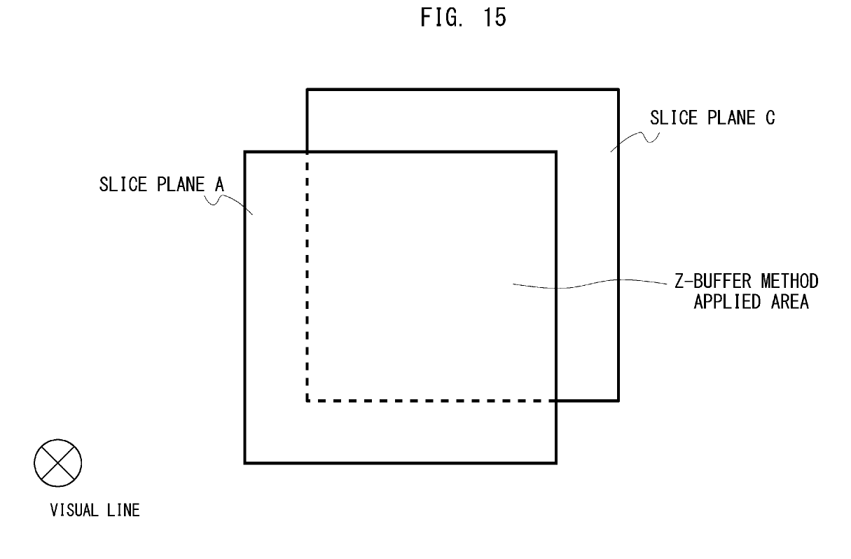

In the example of FIG. 15, the slice plane A serves as the reference plane, while a slice plane C is a slice plane existing posterior to the slice plane A. The slice plane A is rendered earlier, and the slice plane C is rendered later. The rendering is conducted by a Z-buffer method in an area where the slice plane A is overlapped with the slice plane C.

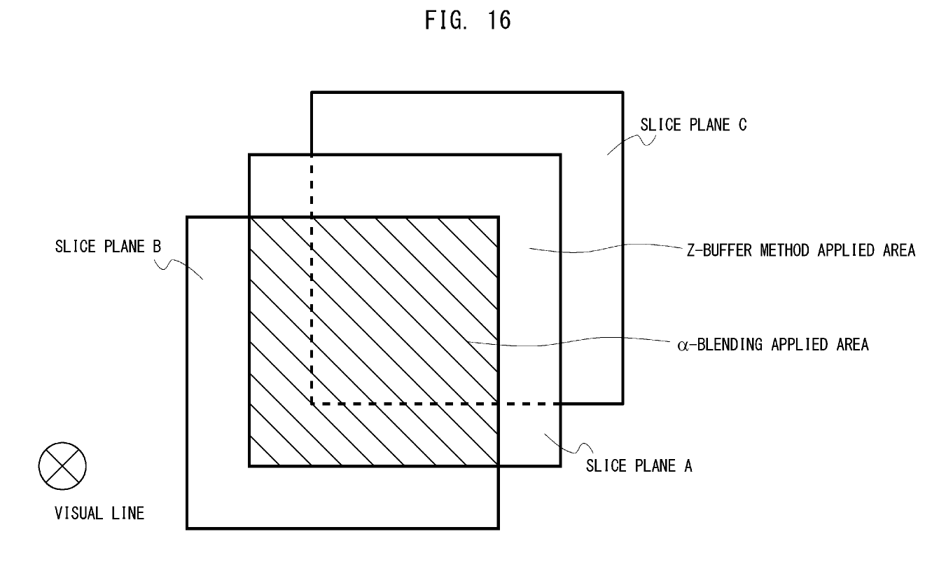

In the example of FIG. 16, the slice plane A serves as the reference plane, the slice plane B is the slice plane existing anterior to the slice plane A, and the slice plane C is a slice plane existing posterior to the slice plane A. The slice planes are rendered in the sequence of the slice plane A, the slice plane B and the slice plane C or in the sequence of the slice plane A, the slice plane C and the slice plane B. The rendering is performed by the α-blending technique in the area where the slice plane A is overlapped with the slice plane B. The rendering is conducted by the Z-buffer method in the area where the slice plane A is overlapped with the slice plane C. Namely, the processing based on the α-blending technique is executed on a nearer side along the visual line than the reference plane, while the processing based on the Z-buffer method is carried out on a deeper side along the visual line than the reference plane.

### MODIFIED EXAMPLE

Next, a modified example of the embodiment discussed above will be described. This modified example has points common to the embodiment discussed above. Accordingly, the description will discuss mainly different points, while the explanations of the common points are omitted.

The processes of the image processing apparatus 100 may be executed in a way that allocates the processes to a server apparatus and a client apparatus, separately. The server apparatus and the client apparatus have the same functions as those of the image processing apparatus 100 described above.

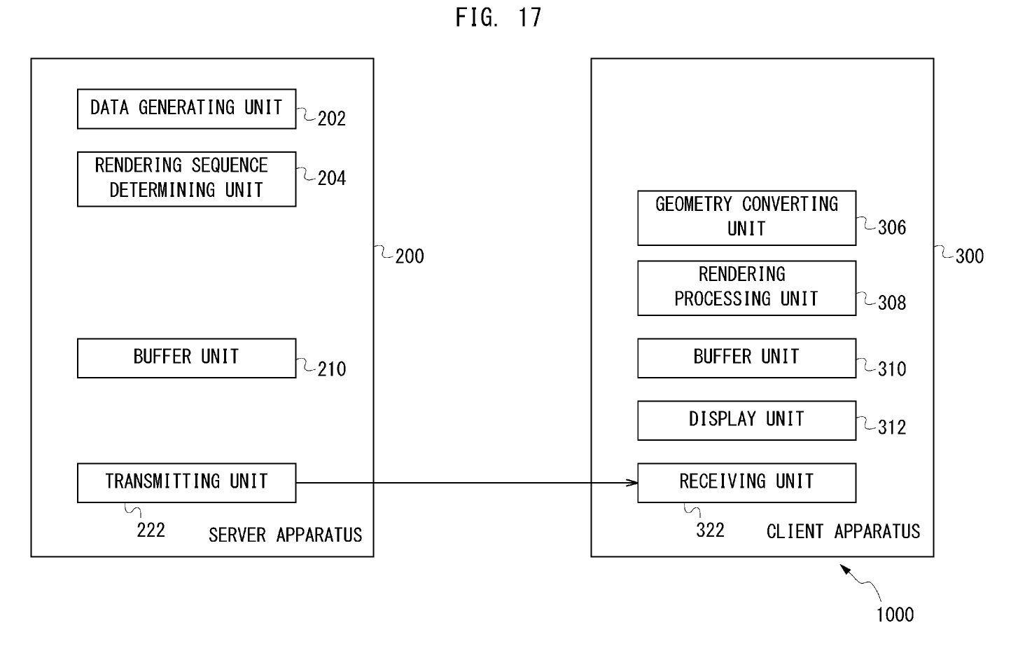

FIG. 17 is a diagram illustrating an example of an image processing system in the present modified example. An image processing system 1000 in FIG. 17 includes a server apparatus 200 and a client apparatus 300. The server apparatus 200 and the client apparatus 300 are connected to each other via, e.g., a network. The server apparatus 200 includes a data generating unit 202, a rendering sequence determining unit 204 and a buffer unit 210. The client apparatus 300 includes a geometry converting unit 306, a rendering processing unit 308, a buffer unit 310 and a display unit 312. These processing units have the same functions of the data generating unit 102, the rendering sequence determining unit 104, the geometry converting unit 106, the rendering processing unit 108, the buffer unit 110 and the display unit 112 in FIG. 1. Further, the server apparatus 200 includes a transmitting unit 222 that transmits the slice plane group data, the texture data and the rendering sequence to the client apparatus. The client apparatus 300 includes a receiving unit that receives the slice plane group data, the texture data and the rendering sequence from the server apparatus 200. The server apparatus 200 may convert the slice plane group data and the texture data in the way of being adjusted to the display screen of the display unit 312 of the client apparatus 300. Namely, the server apparatus 200 may convert the slice plane group data and the texture data to reduce a data size by an operation such as thinning out the data in the way of being adjusted to the display screen of the display unit 312 of the client apparatus 300. The data size being thus reduced, a data traffic between the server apparatus 200 and the client apparatus 300 can be reduced. The slice plane group data and the texture data are referred to also as a plane group.

The server apparatus 200 generates the slice plane group data and the texture data by use of the data generating unit 202 and determines the rendering sequence by use of the rendering sequence determining unit 204. The server apparatus 200 transmits the slice plane group data, the texture data and the rendering sequence to the client apparatus 300.

The client apparatus 300 receives the slice plane group data and the texture data from the server apparatus 200 and stores these items of data on the buffer unit 210. The client apparatus 300 receives designation of the viewpoint data from the user via the input device etc. Next, the client apparatus 300 performs the geometry conversion by using the geometry converting unit 306 and executes the rendering process based on the rendering sequence by employing the rendering processing unit 308. Moreover, the client apparatus 300 displays the rendering-processed images on the display unit 312.

The server apparatus 200 generates the data and determines the rendering sequence, thereby reducing a calculation load on the client apparatus 300. Accordingly, the high-definition rendering process can be executed even when the client apparatus 300 is hardware having a small number of resources (calculation resources and memories).

The server apparatus 200 and the client apparatus 300 can be realized by the dedicated or general-purpose computer such as the personal computer (PC), the server machine, the work station (WS), the PDA (Personal Digital Assistant), the smart phone, the mobile phone and the car navigation system or by use of the electronic equipment mounted with the computer. The transmitting unit 222 of the server apparatus 200 and the receiving unit 322 of the client apparatus 300 can be realized by processors, communication interface devices, etc. of the computer etc.

### Operation and Effect of the Embodiment

The image processing apparatus 100 sets a sequence of rendering the respective slice planes with respect to the slice plane group having a layered structure about at least one direction in a three-dimensional area. The image processing apparatus 100 sets, as the reference plane, any one of the planes exclusive of the slice planes arranged at both ends, and determines the rendering sequence so that the slice planes at both ends are rendered finally. With attachment of a two-dimensional image having the opacity corresponding to each slice plane, the rendering is conducted based on the α-blending technique on the nearer side along the sight line than the reference plane and is also performed based on the Z-buffer method on the deeper side along the sight line than the reference plane in a way that prioritizes the slice plane closer to the reference plane.

On the nearer side (on the side of an observer from whom the visual line originates) than the reference plane, the value data can be displayed minutely or with fidelity by the α-blending technique. On the other hand, on the deeper side than the reference plane, it follows that the value data on the undersurface side are hidden by Z-buffering, however, because of the plane being remote from the observer as the visual line originator, the slice plane is less affected by the value data being hidden than in a case where the value data on the near side are hidden. Namely, whole display efficiency can be improved after prioritizing the display of the value data on the near side, the value data being important to the observer.

According to the image processing apparatus 100, the slice plane group may not be regenerated based on the position of the viewpoint by changing the position of the viewpoint, and the rendering sequence thereof may not be recalculated, whereby a rendering calculation cost can be reduced. Therefore, even when the image processing apparatus 100 is the hardware having the small quantity of resources as in the case of the mobile terminal, the smart phone, etc., the high-definition rendering process can be executed.

The configuration of the present embodiment is effective in such a case that an internal structure of a human body is displayed on the mobile terminal etc., the internal structure being reconfigured from a CT (Computed Tomography) image and an MRT (Magnetic Resonance Tomography) image that are captured in a hospital in, e.g., a medical field. To be specific, the CT image and the MRT image retained on the server are converted into a format usable to the mobile terminal defined as the client apparatus by reducing the data size and are transmitted thereto, while a medical doctor or a patient displays the images based on volume rendering on the mobile terminal via the network. By way of an embodiment in this case, the respective components configuring the image processing apparatus 100 may be mounted on the server and the client separately according to the necessity.

According to the image processing apparatus 100, the efficiency of the whole rendering process can be improved by predetermining a sequence in which the images are rendering-processed without determining this sequence during the rendering process in real time. Namely, according to the image processing apparatus 100, the sequence in which the images are rendering-processed is predetermined, a sorting process using the Z-values for determining the rendering sequence may not be conducted even when a change of the visual line occurs.

The processing by the image processing apparatus 100 has a utility effect as a method of expressing an object suited to the volume rendering for a cloud and a flame. Namely, the processing by the image processing apparatus 100 enables motion-irregular images of the cloud, the flame and a smoke to be displayed in an easily recognizable manner to the user without spoiling the reality on the occasion of expressing these motion-irregular images.

### INDUSTRIAL APPLICABILITY

The image processing apparatus 100 described herein can be applied to displaying results of simulations of, e.g., structural engineering, geology, astrophysics, meteorology, etc. and to expressions of visualizing the clouds, fogs, the flames, etc in games and in movies.

What is claimed is:

1. An image processing apparatus comprising:
control means to set a plane group including a plurality of planes forming layers in at least one direction in a three-dimensional space, to set any one of the planes of the plane group as a reference plane and to form an image on the basis of a positional relationship between a visual line and the reference plane.

2. The image processing apparatus according to claim 1, further comprising first forming means to form, when forming an image of a near-sided plane located on a near side along the visual line between the plurality of planes existing in superposition in a direction of the visual line, the image of the near-sided plane on the basis of opacity in an area where a backward plane located backward of the near-sided plane is overlapped with the near-sided plane,
wherein the control means forms the images by use of the first forming means between the plural planes in a way that prioritizes the plane closer to the reference plane with respect to the planes located on the nearer side along the visual line than the reference plane.

3. The image processing apparatus according to claim 1, further comprising second forming means to form the image of the backward plane in rear of the near-sided plane by omitting an area overlapped with the near-sided plane located on the near side along the visual line between the plurality of planes existing in superposition in the direction of the visual line,
wherein the control means forms the image by use of the second forming means in a way that prioritizes the plane closer to the reference plane with respect to the planes located on the backward side of the reference plane along the visual line.

4. An image processing method by which a computer executes:
a control step of setting a plane group including a plurality of planes forming layers in at least one direction in a three-dimensional space, setting any one of the planes of the plane group as a reference plane and forming an image on the basis of a positional relationship between a visual line and the reference plane.

5. The image processing method according to claim 4, wherein the computer further executes a first forming step of forming, when forming an image of a near-sided plane located on a near side along the visual line between the plurality of planes existing in superposition in a direction of the visual line, the image of the near-sided plane on the basis of opacity in an area where a backward plane located backward of the near-sided plane is overlapped with the near-sided plane,
wherein the control step includes forming the images in the first forming step between the plural planes in a way that prioritizes the plane closer to the reference plane with respect to the planes located on the nearer side along the visual line than the reference plane.

6. The image processing method according to claim 4, wherein the computer further executes a second forming step of forming the image of the backward plane in rear of the near-sided plane by omitting an area overlapped with the near-sided plane located on the near side along the visual line between the plurality of planes existing in superposition in the direction of the visual line,
wherein the control step includes forming the image in the second forming step in a way that prioritizes the plane closer to the reference plane with respect to the planes located on the backward side of the reference plane along the visual line.

7. A computer readable non-transitory recording medium storing an image processing program to make a computer execute:
a control step of setting a plane group including a plurality of planes forming layers in at least one direction in a three-dimensional space, setting any one of the planes of the plane group as a reference plane and forming an image on the basis of a positional relationship between a visual line and the reference plane.

8. The computer readable non-transitory recording medium storing the image processing program according to claim 7, wherein the computer is made to further execute a first forming step of forming, when forming an image of a near-sided plane located on a near side along the visual line between the plurality of planes existing in superposition in a direction of the visual line, the image of the near-sided plane on the basis of opacity in an area where a backward plane located backward of the near-sided plane is overlapped with the near-sided plane,
wherein the control step includes forming the images in the first forming step between the plural planes in a way that prioritizes the plane closer to the reference plane with respect to the planes located on the nearer side along the visual line than the reference plane.

9. The computer readable non-transitory recording medium storing the image processing program according to claim 7, wherein the computer is made to further execute a second forming step of forming the image of the backward plane in rear of the near-sided plane by omitting an area overlapped with the near-sided plane located on the near side along the visual line between the plurality of planes existing in superposition in the direction of the visual line,
wherein the control step includes forming the image in the second forming step in a way that prioritizes the plane closer to the reference plane with respect to the planes located on the backward side of the reference plane along the visual line.

10. An image processing system comprising:
a first information processing apparatus including:
rendering sequence determining means to determine a reference plane from within a plane group including a plurality of planes forming layers in at least one direction, and to determine a rendering sequence in a way that sets the reference plane to be the first in the rendering sequence and prioritizes the plane close to the reference plane; and
transmitting means to transmit the plane group and the rendering sequence determined by the rendering sequence determining means; and
a second information processing apparatus including:
receiving means to receive the plane group and the rendering sequence determined by the rendering sequence determining means; and
control means to synthesize images of the planes of the plane group with a display image on the basis of the direction of a visual line and the rendering sequence.

11. The image processing system according to claim 10, wherein the control means, when synthesizing the image of the plane, synthesizes the image of the plane and the image of the reference plane or the already synthesized display image with a new display image in an area where the image of the plane is overlapped with the image of the reference plane or with the already synthesized display image on the basis of opacity of the plane in the overlapped area when the plane is located on a near side along a visual line.

12. The image processing system according to claim 10, wherein the control means, when synthesizing the image of the plane, synthesizes the image of the plane and the image of the reference plane or the already synthesized display image with a new display image in the area where the image of the plane is overlapped with the image of the reference plane or with the already synthesized display image by omitting the image of the plane in the overlapped area when the plane is located on a backward side along the visual line.
